(19) United States
(12) Patent Application Publication
(10) Pub. No.: US 2023/0022751 A1
(43) Pub. Date: Jan. 26, 2023

(54) LUMPED-PARAMETER ESTIMATION AND UNCERTAINTY QUANTIFICATION FOR SURROGATE MODELING OF PHYSICAL SYSTEMS

(71) Applicant: Palo Alto Research Center Incorporated, Palo Alto, CA (US)

(72) Inventors: Randi Wang, Mountain View, CA (US); Saman Mostafavi, San Francisco, CA (US); Morad Behandish, San Mateo, CA (US)

(73) Assignee: Palo Alto Research Center Incorporated, Palo Alto, CA (US)

(21) Appl. No.: 17/382,834

(22) Filed: Jul. 22, 2021

(51) Int. Cl. G06F 30/20

(52) U.S. Cl. CPC G06F 30/20; G06F 2111/10

(57) ABSTRACT

Methods and systems for modeling physical systems may use a hybrid approach for surrogate modeling that incorporates both modeling based on physical principles and fitting to data. For example, a method for developing a reduced-order models (ROM) of a physical system may comprise: defining a quantity of interest (QoI) for the physical system; defining a lumped-parameter surrogate (LPS) of the physical system based on physical principles; deriving a topology from the LPS; deriving a governing equation of the ROM from the topology, wherein the governing equation has unknown parameters; collecting data about the QoI of the physical system; and fitting the governing equation based on the data to derive values for the unknown parameters and yield the ROM, wherein the ROM approximates the QoI.

### STATEMENT REGARDING FEDERALLY SPONSORED RESEARCH AND DEVELOPMENT

This invention was made with Government support under agreement numbers HR00111990029 and HR00112090065. The Government has certain rights in this invention.

### FIELD OF INVENTION

The present disclosure relates to methods and systems for modeling physical systems.

### BACKGROUND

Generally, when encountered with a new physical system, physicists and engineers start by modeling the system as accurately as possible from the first principles. For example, to predict the dynamical response of a mechanical assembly made of elastic parts to external forces, one has to solve a number of partial differential equations (PDEs) governing spatiotemporal fields representing displacement of various points on geometric models of the assembly components. However, the numerical simulation for such high-fidelity models has a high requirement on computation.

An alternative strategy for modeling a new physical system is using a data-driven method based on machine learning, where a neural network (NN) model is built by training using input/output data. However, such a model requires lots of training data generated from high-fidelity simulation or experiment, is generally not reliable, repeatable, or interpretable. For example, if the shape/material parameters or initial/boundary conditions are changed, the model needs to be trained again.

Therefore, additional strategies for modeling a new physical system that have reasonable computational time and robust fidelity are needed.

### SUMMARY OF INVENTION

The present disclosure relates to methods and systems for modeling physical systems. More specifically, the methods and systems of the present disclosure use a hybrid approach for surrogate modeling that incorporates both modeling based on physical principles and fitting to data.

The present disclosure further includes methods for developing a reduced-order models (ROM) of a physical system, the methods comprising: defining a quantity of interest (QoI) for the physical system; defining a lumped-parameter surrogate (LPS) of the physical system based on physical principles; deriving a topology from the LPS; deriving a governing equation of the ROM from the topology, wherein the governing equation has unknown parameters; collecting data about the QoI of the physical system; and fitting the governing equation based on the data to derive values for the unknown parameters and yield the ROM, wherein the ROM approximates the QoI.

The present disclosure further includes methods for developing a reduced-order models (ROM) of a physical system, the methods comprising: defining a quantity of interest (QoI) for the physical system; defining a lumped-parameter surrogate (LPS) of the physical system based on physical principles; deriving a topology from the LPS; deriving a governing equation of the ROM from the topology, wherein the governing equation has unknown parameters; collecting data about the QoI of the physical system; fitting the governing equation based on the data to derive values for the unknown parameters and yield the ROM, wherein the ROM approximates the QoI; and quantifying an uncertainty of the ROM, wherein quantifying comprises: assigning a probability density function to each of the unknown parameters; deriving a probabilistic ROM based on the data and the probability density function; estimating the unknown parameters using a sampling technique coupled with a parameter estimation technique to produce a set of estimated parameters; and running the ROM using the set of estimated parameters to produce a confidence interval for each parameter in the set of estimated parameters, thereby quantifying an uncertainty of the ROM

The present disclosure further includes systems that comprises: a processor; a memory coupled to the processor; and instructions provided to the memory, wherein the instructions are executable by the processor to cause the system to perform the method according to one or both of the foregoing methods.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a flow diagram of a nonlimiting example method of the present disclosure.

FIGS. 2A-2G illustrate the nonlimiting example method in FIG. 1 being applied to an example problem involving physics-based lumped parameter modeling of the mechanical behavior of a chair.

FIG. 2H illustrates how the hybrid surrogate modeling approach works by using first principles and data to obtain a reduced order model (ROM).

FIG. 3 a flow diagram of a nonlimiting example method of the present disclosure for quantifying the uncertainty of the ROM.

FIGS. 4A-4B illustrate various aspects of deriving a ROM for a compressible rod made of homogeneous elastic material, using two different topologies for the lumped network.

FIGS. 5A-5B illustrate various aspects of deriving a ROM for a simple chair made of homogeneous elastic material, using two different topologies for the lumped network.

### DETAILED DESCRIPTION

The present disclosure relates to methods and systems for modeling physical systems. More specifically, the methods and systems of the present disclosure use a hybrid approach for surrogate modeling that incorporates both modeling based on physical principles and fitting to data. The hybrid nature of the approach brings together the benefits of both model-based and data-driven approaches and alleviates their limitations when used in isolation.

Briefly, the physical system may be modeled by a lumped-parameter surrogate model governed by a system of temporal ordinary differential equations (ODEs), while geometric details are captured by lumped parameters. In the model-based portion of the hybrid approach, physical principles including first principles as well as heuristic geometric and physics-inspired rules are used to select a topological structure for the lumped-parameter surrogate. For example, Tonti diagrams may be applied systematically to generate the governing equations (more specifically, governing ODEs) from the topological structure. These governing equations have unknown constitutive parameters (e.g., coefficients). The data-based portion of the hybrid approach fits the governing equations to data (e.g., experimental data, high-fidelity simulation data, or a combination thereof) to estimate the unknown parameters. In other words, data driven regression (i.e., fitting) is performed to estimate the parameters of the governing equations to obtain a reduced-order model (ROM), such that the ROM best approximates certain quantities of interest (QoI) (e.g., minimizes an error function), where the ground truth values of the QoI are obtained from experiment and/or high-fidelity simulation. The ROM is defined by a combination of the governing equations and the estimated parameters.

There are at least two different ways to define an error function: “equation fitting” and “solution fitting”. In the equation fitting approach, one can use the residual error of the ODE (i.e., how well the data satisfies the equations for a given set of parameters) and find the parameters that minimize this error. The advantage of this approach is that it does not require solving the PDEs during training, as a forward evaluation suffices to evaluate the residual error. The drawback, however, is that a minimal residual error does not necessarily yield minimal error in QoIs, especially in highly nonlinear chaotic ODEs. In the solution fitting approach, the ODEs are solved in the training loop to acquire a solution, whose error against the data can be evaluated. In both approaches, a single error can be computed from error values distributed in space (over the lumped network) and time using, for example, mean-squared error (MSE), mean absolute error (MAE), mean magnitude relative error (MMRE), Manhattan distance (MD), mean absolute deviation (MAD), and the like. The resulting ROM may be used for faster prediction of the QoIs in applications that require numerous simulations (e.g., design or real-time control). Further, as additional data is collected in real-time, the ROM may be updated by re-estimating the parameters of the governing equations.

In the hybrid methods described herein, the structure of the governing equations is informed by physical principles, and the parameters of the governing equations are estimated from data. The governing equations have unknown coefficients that parameterize phenomenological relations, meaning that the values of these unknown parameters cannot be directly obtained from first principles. For example, if a lumped parameter model such as a mass-spring-damper network is used to replicate the second-order Newtonian dynamics of a loaded mechanical assembly, the stiffness and damping coefficients of the governing equations depend on the shape of the components and material properties such as elasticity and viscosity in a nontrivial fashion. The topological structure that determines how springs and dampers are interconnected ensures preservation of important physical principles such as superposition of forces and conservation of momentum and energy. Although the values of the stiffness and damping coefficients may not be directly inferable from shape and material properties, said values can be learned from data to minimize the error of the ROM predictions while the aforementioned structure and principles remain intact and are built into the surrogate model. These principles are enforced strongly and may not be compromised due to the error or noise that might be present in the data.

In addition to the hybrid approach to achieve a ROM, the present disclosure includes uncertainty quantification (UQ) of the ROM that may be performed by deriving the parameters of the governing equations in a probabilistic framework, to not only learn the near-optimal values of the parameters that minimizes the overall error, but also quantify probability distributions for the parameters, revealing a degree of confidence in the learned process and the resulting model output. Particularly, a posterior probability distribution for each parameter of the model may be determined by assuming a parametrized family of distributions (e.g., Gaussians parameterized by a mean and a standard derivation) and learning the parameters of those probability distribution function. For example, in a mass-spring-damper network, one may learn the mean and standard deviation for assumed Gaussian distributions of the stiffness and damping coefficients that minimizes the discrepancy between the measured spring displacement and system (ODE) response to a particular input (scored by the aforementioned similarity metrics). This process can be achieved with minimal alterations to the existing approaches for deterministic parameter estimations. For example, in the case of Gaussians, the computational complexity of the standard learning problem is increased by a factor of two since the mean and standard deviation for each coefficient is learned instead of a single deterministic value. Hence, little is lost in terms of computational complexity. However, by changing a traditional parameter estimation to a Bayesian one, simultaneous parameter estimation and uncertainty quantification can be achieved in a minimally intrusive manner.

There are several advantages of the methods and systems described herein that use a hybrid approach to achieve a ROM, compared to that of the state of the art. For example, unlike purely data-driven models that are usually difficult to interpret or explain, the lumped-parameter surrogate model has a clear physical interpretation whose behavior could be quantitatively and explicitly interpreted both locally and globally through observing the component connectivity and types of constitutive equations. Furthermore, in comparison with traditional “regression” approaches such as feed-forward neural networks to predict QoIs from initial/boundary conditions, which are prone to poor prediction performance with respect to out-of-training data, uncertainty quantification allows avoiding over-confident predictions for regions of input space that are not sampled adequately for training in an adaptive manner.

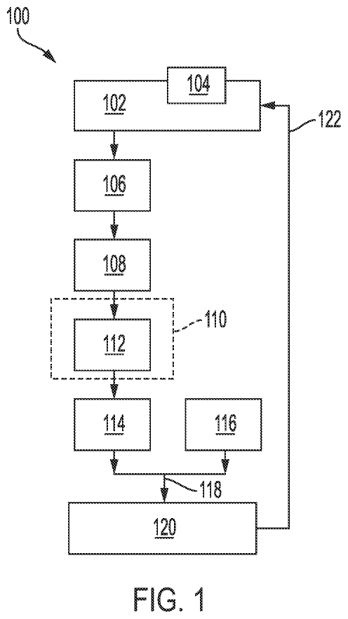

FIG. 1 is a flow diagram of a nonlimiting example method 100 of the present disclosure for producing a reduced order model (ROM) 120 of a physical system 102 that describes a quantity of interest 104 relating to or of the physical system 102 using the hybrid approach described herein. The quantity of interest (QoI) 104 may, for example, be the average displacement on a surface of a given solid part in a mechanical system.

The physical system 102 may first be converted into a lumped-parameter model (LPM) 106 based on physical principles (e.g., Newton's laws of motion, Kirchhoff's circuit laws, conservation of mass, momentum, charge, energy, and the like). When determining the LPM 106, the QoI 104 should be considered. Preferably, the LPM 106 is as simple as possible but still suitable for later deriving the QoI 104 from the ROM 120.

Any physical system may be used ranging from simple systems like a pendulum swinging or a simple circuit to complex systems like an internal combustion engine, a polymer synthesis reactor, or a ventricular assist device. When producing the LPM 106, the individual physics aspects of physical system 102 are considered and converted to LPM 106. Herein, these individual physics aspects are referred to as physics-based systems and, more specifically, mechanical systems, electrical systems, thermal systems, and the like, and hybrid systems that incorporate one or more aspects of any combination of the foregoing systems. The LPM 106 of the physical system 102 may include multiple types of physics-based systems and one or more of an individual physics-based system.

Mechanical, electrical, thermal, and multi-physics combinations of them may be modeled by LPM including lumped components and constitutive equations relating lumped variables, e.g., springs and dampers (mechanical), resistors, capacitors, and inductors (electrical), thermal/fluidic resistors, and so on.

Referring again to FIG. 1, the structure of the LPM 106 of the physical system 102 may then be used to derive a topological representation 108, using an abstract cell complex. For example, the topology 108 may be a representation (e.g., graph) comprising nodes and edges, wherein lumped variables of the LPM including QoI are associated with nodes while the edges capture pairwise relationships among the variables that lead to ODEs.

Derivation of the topology 108 may include proximity criteria among the lumped components (e.g., lumped masses represented by interacting particles). Examples of proximity criteria include, but are not limited to, k-nearest-neighbor (kNN) connections, Delaunay triangulation, distance threshold criteria, and the like, and any combination thereof.

The topology 108 is then the basis for deriving 110 governing equations 114 (more specifically, governing ODEs) of the ROM 120. In the illustrated nonlimiting example method 100, deriving 110 the governing equations 114 includes following a systematic approach to convert the LPM topology 108 to a set of ODEs, including but not limited to, traversing paths along a Tonti diagram 112. The governing equations 114 have unknown parameters. For example, the governing equations 114 may have the form of EQ. 1 where M, C, and K are mass, damping, and stiffness matrices whose (potentially sparse) shape depends on the topology, and contain unknown parameters. The vectors x(t) and f(t) represent the state variables and external stimulus vectors.

M\ddot{x}(t)+C\dot{x}(t)+Kx(t)=f(t) EQ. 1

The governing equations 114 with unknown symbolic parameters (e.g., coefficients) and variables is the output of the model-based portion of the hybrid approach described herein. Then, the data-driven portion estimates the unknown parameters of the governing equation 116 by fitting 118 the governing equations 114 to the data while minimizing an error (e.g., using standard methods such as least-square regression). The ROM is defined by the governing equation with the estimated parameters obtained by the fitting 118 the governing equations 116 to the data 116.

The data 116 may be experimental data, simulated data, calculated data from closed-form solutions, and the like, and any combination thereof. The simulated data may be from a high-fidelity physical model where the resultant ROM 120 may be used for more rapid modeling of the physical system 102 as compared to the high-fidelity physical model.

Fitting 118 the governing equations 114 to the data 116 to estimate the unknown parameters of the governing equations may be achieved by any suitable technique. Examples of fitting techniques include, but are not limited to, optimization (including regression, curve-fitting, and statistical/machine learning), system identification, and the like. Examples of machine learning techniques include, but are not limited to, neural networks, kernel methods, reinforcement learning methods, and the like. Examples of neural networks include, but are not limited to, recurrent neural network, convolutional neural network (CNN), long short term memory (LSTM) networks, auto encoder, and the like. Example of kernel methods include, but are not limited to, polynomial, radial basis function (RBF), graph kernels, and the like.

The resultant ROM 120 may then be executed 122 to determine the QoI 104 under various conditions. In the examples described herein, the lumping occurs in 3D space, resulting in QoIs that are predicted as spatially integrated properties as a function of time (e.g., temporal signals). However, alternative embodiments may use different combinations of independent variables or coordinates for lumping. For example, rather than averaging a mechanical assembly made of 3D models into a network of lumped masses (neglecting the geometry altogether) connected with springs and dampers, one may reduce the original 3D geometry to 2D geometry by exploiting approximate symmetries (e.g., almost-axisymmetric aerodynamic bodies). The partial lumping results in effective parameters that appear as coefficients in the reduced-order PDEs/ODEs that depend on asymmetries and neglected geometric dimensions in addition to material properties. As with full lumping, the coefficients can be learned from data.

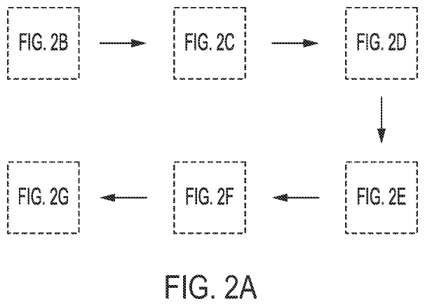

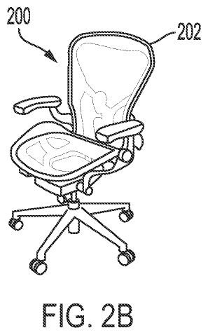

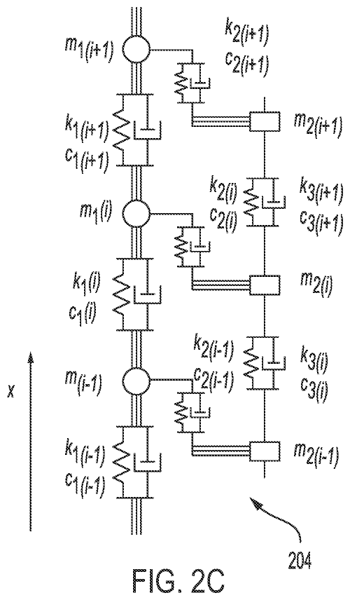

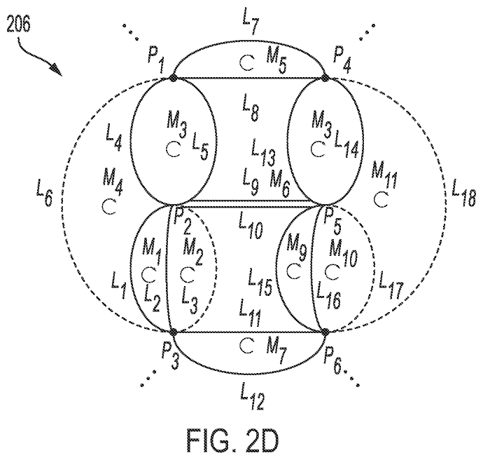

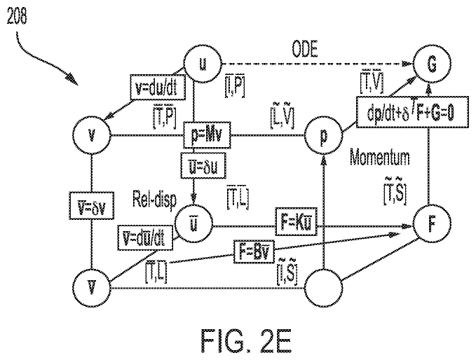

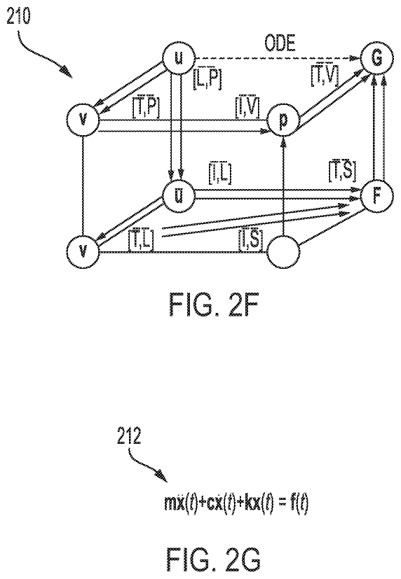

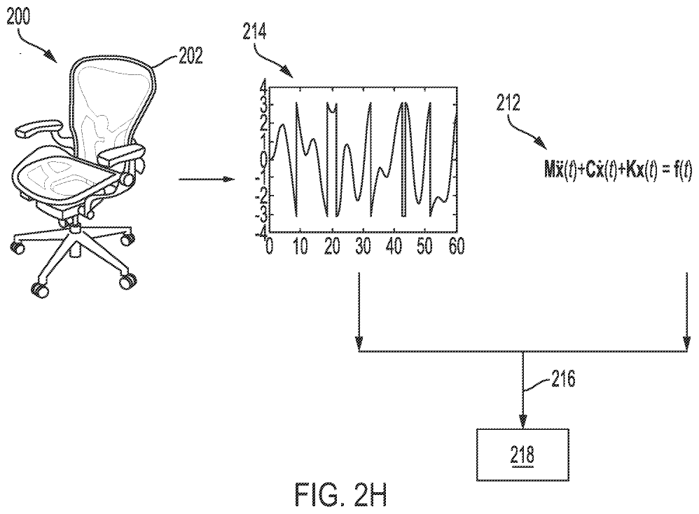

FIGS. 2A-2H illustrate a more detailed nonlimiting example of the method 200 of the present disclosure using the suspension assembly of a desk chair 202 as the physical system. The steps illustrated in FIG. 2A-2G are the model-based portion of the hybrid approach described herein. In FIG. 2H, the data-driven portion and the combining of the two portions of the hybrid approach described herein are illustrated. In this example, one of the QoIs could be the height of the seat (e.g., defined as the average displacement of the seating surface as a function of time) as a weight is added or removed from it.

The suspension assembly of the desk chair 202 is first represented by a symbolic LPM 204 whose topology is captured by an oriented cell complex 206 to which the Tonti diagram of system models 208 (u is absolute displacement, ū is relative displacement, v is absolute velocity, ν̅ is relative velocity, G is external forces, F is internal forces,) can be applied. The paths 210 along the Tonti diagram are then used to derive the governing system of ODEs 212 (also referred to as the governing equations 212). Then, as illustrated in FIG. 2H, data 214 (e.g., collected from experiments performed on and/or high-fidelity models relative to the chair 202 relative to the QoI) is used to estimate 216 the parameters (illustrated as M, C, and K) of the governing equations 212 to yield the ROM 218.

Methods and systems of the present disclosure may be further extended to deal with the uncertainties in the ROMs described herein. In such methods and systems, a probability density function (PDF) is assigned to each of the estimated parameters (e.g., M, C, and K of FIGS. 2A-2H) referred to herein as “estimated probabilistic parameters” rather than a single value. The estimated probabilistic parameters may be achieved using any number of parameter estimation techniques in a probabilistic framework such as Bayesian backpropagation, Markov Chain Monte Carlo (MCMC) methods, and the like, and any combination thereof.

The probabilistic framework may include defining (e.g., by a user) a prior probability distribution function to be used for parameters uncertainty of governing equation 210. Examples of PDF include, but are not limited to, Gaussian, uniform, exponential, and the like.

After defining the prior probability distribution function, the parameters of the ROM may be estimated using a sampling technique (e.g., Monte Carlo sampling) (and/or other probabilistic methods such as variational inference, and the like) coupled with a parameter estimation technique to derive a posterior PDF for each parameter of the ROM. The posterior PDF quantifies the parameter uncertainty of the ROM model. Finally, sampling the set of derived probabilistic parameters (sample size is a function of size of the parameter space) and solving the ROM for the sampled parameter sets produces a set of outputs with a confidence interval that quantifies the output uncertainty of the ROM.

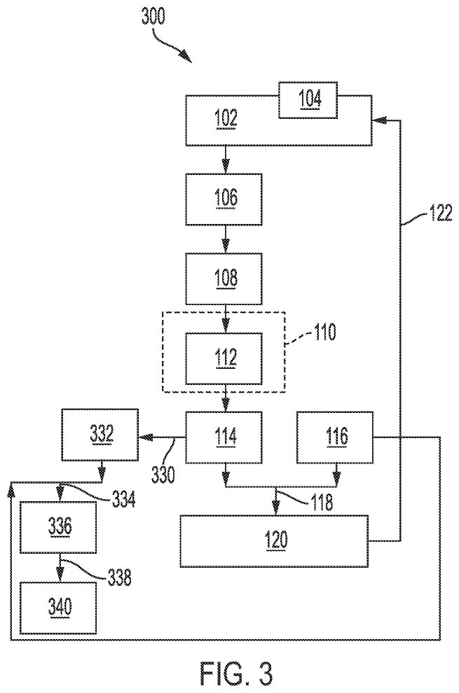

FIG. 3 a flow diagram of a nonlimiting example method 300 of the present disclosure for quantifying the uncertainty of the ROM 120. FIG. 3 references the flow diagram of FIG. 1 where the description above of FIG. 1 applies to FIG. 3. In this example method 300, the governing equations 114 are re-parameterized 330 to include parameterized PDFs 332, then using the data 116 and the PDFs 332 a Bayesian learning structure, for example, may be applied to derive 334 the probabilistic ROM 336. Then, the probabilistic ROM 336 may be sampled and ran to quantify 338 the uncertainty 340.

Advantageously, the additional derivation of the uncertainties (e.g., as illustrated in FIG. 3) may be deployed with minimal alterations to existing the learning architectures assembled from Tonti diagrams (e.g., the machine learning architecture or other suitable architecture used in the parameter estimation), especially where the weights are crisp (i.e., a single value per parameter without confidence intervals). Hence, the learning architectures assembled from Tonti diagrams may be converted to Bayesian learning structures for simultaneous parameter estimation and uncertainty quantification.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can, and in many embodiments must, be performed using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”). For example, a system may comprise: a processor; a memory coupled to the processor; and instructions provided to the memory, wherein the instructions are executable by the processor to cause a system to: define a quantity of interest (QoI) for the physical system; define a lumped-parameter surrogate (LPS) of the physical system based on physical principles; derive a topology from the LPS; derive a governing equation of the ROM from the topology, wherein the governing equation has unknown parameters; collect data about the QoI of the physical system; and fit the governing equation based on the data to derive values for the unknown parameters and yield the ROM, wherein the ROM approximates the QoI. In another example, a system may comprise: a processor; a memory coupled to the processor; and instructions provided to the memory, wherein the instructions are executable by the processor to cause a system to: define a quantity of interest (QoI) for the physical system; define a lumped-parameter surrogate (LPS) of the physical system based on physical principles; deriving a topology from the LPS; derive a governing equation of the ROM from the topology, wherein the governing equation has unknown parameters; collecting data about the QoI of the physical system; fit the governing equation based on the data to derive values for the unknown parameters and yield the ROM, wherein the ROM approximates the QoI; and quantify an uncertainty of the ROM, wherein quantifying comprises: assign a probability density function to each of the unknown parameters; derive a probabilistic ROM based on the data and the probability density function; estimate the unknown parameters using a sampling technique coupled with a parameter estimation technique to produce a set of estimated parameters; and run the ROM using the set of estimated parameters to produce a confidence interval for each parameter in the set of estimated parameters, thereby quantifying an uncertainty of the ROM.

Similarly, any calculation, determination, or analysis recited as part of methods described herein may be carried out in whole or in part using a computer.

Furthermore, the instructions of such computing devices or processor-based devices can be a portion of code on a non-transitory computer readable medium. Any suitable processor-based device may be utilized for implementing all or a portion of embodiments of the present techniques, including without limitation personal computers, networks, personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

### EXAMPLE EMBODIMENTS

A first nonlimiting example embodiment of the present disclosure is a method for developing a reduced-order models (ROM) of a physical system, the method comprising: defining a quantity of interest (QoI) for the physical system; defining a lumped-parameter surrogate (LPS) of the physical system based on physical principles; deriving a topology from the LPS; deriving a governing equation of the ROM from the topology, wherein the governing equation has unknown parameters; collecting data about the QoI of the physical system; and fitting the governing equation based on the data to derive values for the unknown parameters and yield the ROM, wherein the ROM approximates the QoI.

A second nonlimiting example embodiment of the present disclosure is a system comprising: a processor; a memory coupled to the processor; and instructions provided to the memory, wherein the instructions are executable by the processor to cause the system to perform the method of first nonlimiting example embodiment.

The first and/or second nonlimiting example embodiments may further include one or more of: Element 1: wherein the topology is an abstract cell complex; Element 2: wherein the deriving of the governing equation comprises representing the topology with a Tonti diagram and using one or more paths of the Tonti diagram to define derive the governing equation; Element 3: wherein the data comprises simulated data; Element 4: wherein the data comprises experimental data; Element 5: wherein the data comprises calculated data from closed-form solutions; Element 6: wherein the LPS of the physical system includes components relating to a mechanical system of the physical system, an electrical system of the physical system, a thermal system of the physical system, or any combination thereof; Element 7: wherein the topology is a graph comprising nodes and edges, wherein lumps of the LPS and QoI are associated with nodes, and wherein the parameters for the governing equation are the edges; Element 8: wherein deriving the topology uses proximity criteria between lumps of the LPS; Element 9: wherein the governing equation is an ordinary differential equation (ODE); and Element 10: wherein the fitting of the parameters of the governing equation uses a technique selected from the group consisting of: optimization, regression, machine learning, and system identification. Examples of combinations include, but are not limited to, Element 1 in combination with one or more of Elements 2-10; Element 2 in combination with one or more of Elements 3-10; Element 3 in combination with one or more of Elements 4-10; two or more of Elements 3-5 in combination and optionally in further combination with one or more of Elements 6-10; Element 4 in combination with one or more of Elements 5-10; Element 5 in combination with one or more of Elements 6-10; Element 7 in combination with one or more of Elements 8-10; and two or more of Elements 8-10 in combination.

A third nonlimiting example embodiment of the present disclosure is a method for developing a reduced-order models (ROM) of a physical system, the method comprising: defining a quantity of interest (QoI) for the physical system; defining a lumped-parameter surrogate (LPS) of the physical system based on physical principles; deriving a topology from the LPS; deriving a governing equation of the ROM from the topology, wherein the governing equation has unknown parameters; collecting data about the QoI of the physical system; fitting the governing equation based on the data to derive values for the unknown parameters and yield the ROM, wherein the ROM approximates the QoI; and quantifying an uncertainty of the ROM, wherein quantifying comprises: assigning a probability density function to each of the unknown parameters; deriving a probabilistic ROM based on the data and the probability density function; estimating the unknown parameters using a sampling technique coupled with a parameter estimation technique to produce a set of estimated parameters; and running the ROM using the set of estimated parameters to produce a confidence interval for each parameter in the set of estimated parameters, thereby quantifying an uncertainty of the ROM

A fourth nonlimiting example embodiment of the present disclosure is a system comprising: a processor; a memory coupled to the processor; and instructions provided to the memory, wherein the instructions are executable by the processor to cause the system to perform the method of third nonlimiting example embodiment.

The third and/or fourth nonlimiting example embodiments may further include one or more of: Element 1; Element 2; Element 3; Element 4; Element 5; Element 6; Element 7; Element 8; Element 9; Element 10; and Element 11: the deriving of the probabilistic ROM uses a Bayesian learning structure. Examples of combinations include, but are not limited to, Element 1 in combination with one or more of Elements 2-11; Element 2 in combination with one or more of Elements 3-11; Element 3 in combination with one or more of Elements 4-11; two or more of Elements 3-5 in combination and optionally in further combination with one or more of Elements 6-11; Element 4 in combination with one or more of Elements 5-11; Element 5 in combination with one or more of Elements 6-11; Element 7 in combination with one or more of Elements 8-11; and two or more of Elements 8-11 in combination.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

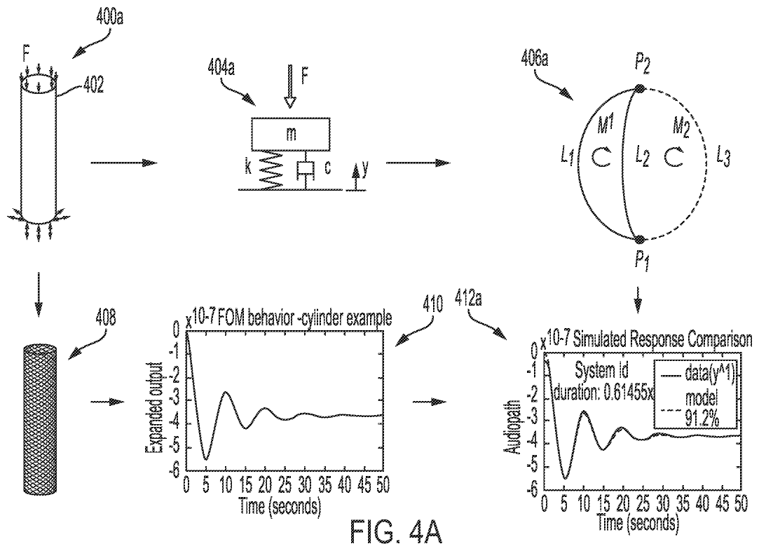

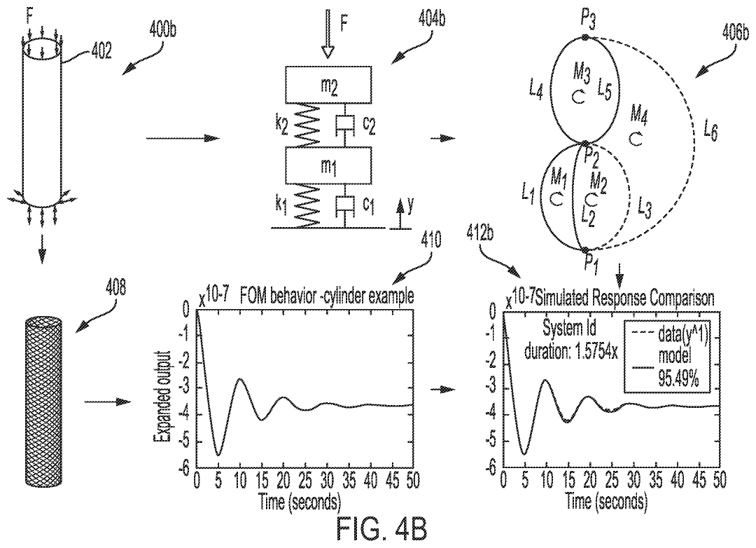

Example 1. FIG. 4A illustrates various aspects of this example 400a of deriving a ROM for a compressible rod 402, which was the physical system of this example. A force F was applied to the compressible rod 402 placed on a non-compressible surface with the QoI being the average displacement of the top of the rod as a function of time. The LPS 404a was defined using a rigid mass with mass m, a spring with a spring constant k, and a damper with a dampening constant c. From the LPS 404a, a topology 406a was derived. From the topology 406a, a governing equation (not illustrated) was derived and had the general form of EQ. 1.

The data 410 used for fitting the governing equation was simulated data from a high-fidelity model using the compressible rod 402 simulated in a tetrahedron mesh configuration 408. Fitting the governing equation to the simulated data 410 yielded a ROM with m=3.313*10⁵ kg, k=1.392*10⁵ N/m, and c=5.329*10⁵ kg/s. The plot 412a illustrates a comparison between the simulated data 410 and the ROM. The ROM had a normalized root mean square error of 8.8% as compared to the simulated data 410.

Example 2. This example 400b was performed the same as Example 1 but with a different LPS 404b. FIG. 4B illustrates various aspects of this example of deriving a ROM for the compressible rod 402. In this example, the LPS 404b was defined using two rigid masses with masses m₁ and m₂, two springs with spring constants k₁ and k₂, and two dampers with dampening constants c₁ and c₂. From the LPS 404b, a topology 406b was derived. From the topology 406b, a governing equation (not illustrated) was derived with m₁=2.303*10⁵ kg, m₂=2.047*10⁵ kg, k₁=1.994*10⁵ N/m, k₂=4.459*10⁵ N/m, c₂=1.1*10⁵ kg/s, and c₂=2.382*10⁵ kg/s. The plot 412b illustrates a comparison between the simulated data 410 and the ROM. In this example, the ROM had a normalized root mean square error of 4.51% as compared to the simulated data 410.

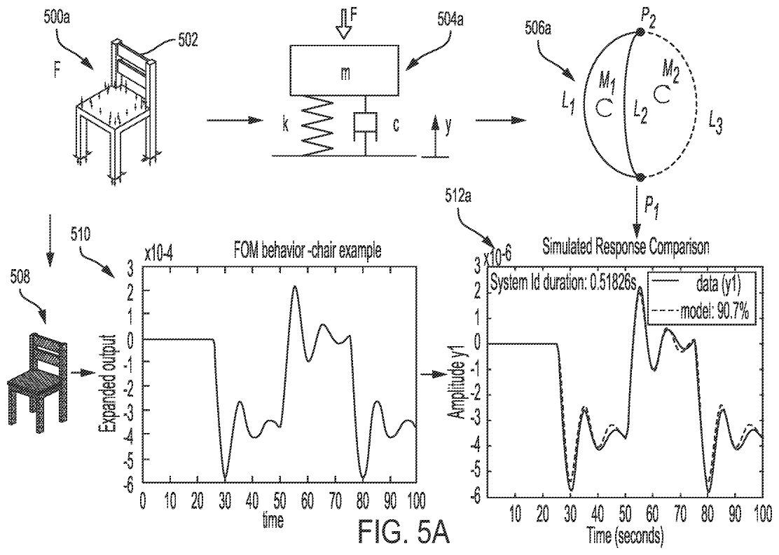

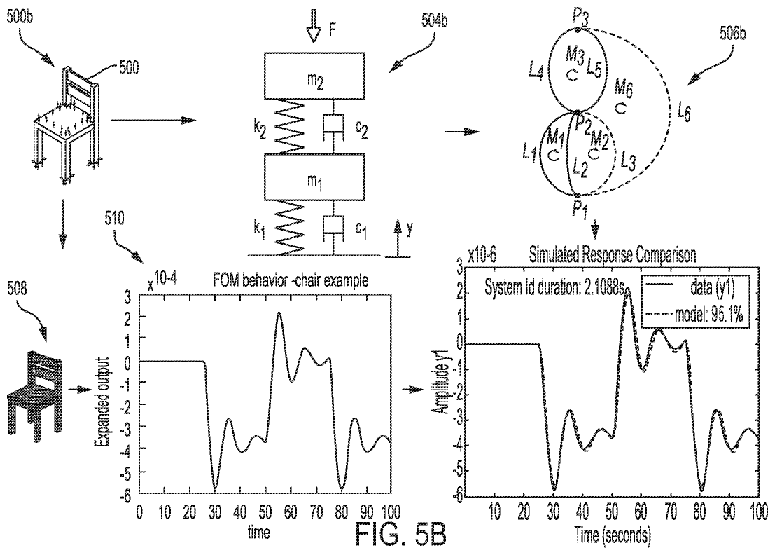

Example 3. FIG. 5A illustrates various aspects of this example 500 of deriving a ROM for a chair 502, which was the physical system of this example. A force F was applied to the seat of the chair 502 with the QoI being the average displacement of the top of the rod as a function of time. The LPS 504a was defined using a rigid mass with mass m, a spring with a spring constant k, and a damper with a dampening constant c. From the LPS 504a, a topology 506a was derived. From the topology 506a, a governing equation (not illustrated) was derived and had the general form of EQ. 1.

The data 510 used for fitting the governing equation was simulated data from a high-fidelity model using the chair 502 simulated in a tetrahedron mesh configuration 508. Fitting the governing equation to the simulated data 510 yielded a ROM with m=7.428*10⁴ kg, k=2.787*10⁴ N/m, and c=1.154*10⁵ kg/s. The plot 512a illustrates a comparison between the simulated data 510 and the ROM. The ROM had a normalized root mean square error of 9.3% as compared to the simulated data 510.

Example 4. This example 500b was performed the same as Example 1 but with a different LPS 504b. FIG. 5B illustrates various aspects of this example of deriving a ROM for the chair 502. In this example, the LPS 504b was defined using two rigid masses with masses m₁ and m₂, two springs with spring constants k₁ and k₂, and two dampers with dampening constants c₁ and c₂. From the LPS 504b, a topology 506b was derived. From the topology 506b, a governing equation (not illustrated) was derived with m₁=3.624*10⁴ kg, m₂=5.593*10⁴ kg, k₁=3.876*10⁴ N/m, k₂=9.666*10⁴ N/m, c₂=2.614*10⁴ kg/s, and c₂=4.189*10⁴ kg/s. The plot 512b illustrates a comparison between the simulated data 510 and the ROM. In this example, the ROM had a normalized root mean square error of 4.89% as compared to the simulated data 510.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method for developing a reduced-order models (ROM) of a physical system, the method comprising:
defining a quantity of interest (QoI) for the physical system;
defining a lumped-parameter surrogate (LPS) of the physical system based on physical principles;
deriving a topology from the LPS;
deriving a governing equation of the ROM from the topology, wherein the governing equation has unknown parameters;
collecting data about the QoI of the physical system; and
fitting the governing equation based on the data to derive values for the unknown parameters and yield the ROM, wherein the ROM approximates the QoI.

2. The method of claim 1, wherein the topology is an abstract cell complex.

3. The method of claim 1, wherein the deriving of the governing equation comprises representing the topology with a Tonti diagram and using one or more paths of the Tonti diagram to define derive the governing equation.

4. The method of claim 1, wherein the data comprises simulated data.

5. The method of claim 1, wherein the data comprises experimental data.

6. The method of claim 1, wherein the data comprises calculated data from closed-form solutions.

7. The method of claim 1, wherein the LPS of the physical system includes components relating to a mechanical system of the physical system, an electrical system of the physical system, a thermal system of the physical system, or any combination thereof.

8. The method of claim 1, wherein the topology is a graph comprising nodes and edges, wherein lumps of the LPS and QoI are associated with nodes, and wherein the parameters for the governing equation are the edges.

9. The method of claim 1, wherein deriving the topology uses proximity criteria between lumps of the LPS.

10. The method of claim 1, wherein the governing equation is an ordinary differential equation (ODE).

11. The method of claim 1, wherein the fitting of the parameters of the governing equation uses a technique selected from the group consisting of: optimization, regression, machine learning, and system identification.

12. A system comprising:
a processor;
a memory coupled to the processor; and
instructions provided to the memory, wherein the instructions are executable by the processor to cause the system to perform the method of claim 1.

13. A method for developing a reduced-order models (ROM) of a physical system, the method comprising:
defining a quantity of interest (QoI) for the physical system;
defining a lumped-parameter surrogate (LPS) of the physical system based on physical principles;
deriving a topology from the LPS;
deriving a governing equation of the ROM from the topology, wherein the governing equation has unknown parameters;
collecting data about the QoI of the physical system;
fitting the governing equation based on the data to derive values for the unknown parameters and yield the ROM, wherein the ROM approximates the QoI; and
quantifying an uncertainty of the ROM, wherein quantifying comprises:
assigning a probability density function to each of the unknown parameters;
deriving a probabilistic ROM based on the data and the probability density function; and
estimating the unknown parameters using a sampling technique coupled with a parameter estimation technique to produce a set of estimated parameters; and
running the ROM using the set of estimated parameters to produce a confidence interval for each parameter in the set of estimated parameters, thereby quantifying an uncertainty of the ROM.

13. The method of claim 13, the deriving of the probabilistic ROM uses a Bayesian learning structure.

14. The method of claim 13, wherein the topology is an abstract cell complex.

15. The method of claim 13, wherein the deriving of the governing equation comprises representing the topology with a Tonti diagram and using one or more paths of the Tonti diagram to define derive the governing equation.

16. The method of claim 13, wherein the data comprises simulated data.

17. The method of claim 13, wherein the data comprises experimental data.

18. The method of claim 13, wherein the data comprises calculated data from closed-form solutions.

19. The method of claim 13, wherein the LPS of the physical system includes components relating to a mechanical system of the physical system, an electrical system of the physical system, a thermal system of the physical system, or any combination thereof.

20. A system comprising:
a processor;
a memory coupled to the processor; and
instructions provided to the memory, wherein the instructions are executable by the processor to cause the system to perform the method of claim 13.
